(19) United States
(12) Patent Application Publication
(10) Pub. No.: US 2026/0260513 A1
(43) Pub. Date: Sep. 3, 2026

(54) SYSTEMS AND METHODS FOR IDENTIFYING AN OBJECT OF INTEREST FROM IMAGE DATA

(71) Applicant: Halocon, Inc., St. Louis, MO (US)

(72) Inventors: John Wall, St. Louis, MO (US); Eric Peter Hinckley, Superior, CO (US); Madeline Amelia Cameron, Easton, PA (US); Sir George W. Buckley, North Barrington, IL (US)

(21) Appl. No.: 19/554,057

(22) Filed: Mar. 2, 2026

Related U.S. Application Data
(60) Provisional application No. 63/765,144, filed on Feb. 28, 2025.

(51) Int. Cl. G06V 40/16; G06V 10/82; H04W 4/029

(52) U.S. Cl. CPC G06V 40/172; G06V 10/82; H04W 4/029

(57) ABSTRACT

An identification system for use in identifying an object of interest is provided. The identification system includes a plurality of image capture devices, and a controller. The plurality of image capture devices are configured to transmit data in real-time to the controller on demand. The controller is programmed to receive at least one image of an object of interest from a user, compare the at least one image of an object of interest received from the user to data transmitted from the plurality of image capture devices, identify the object of interest from the data transmitted from the plurality of image capture devices using at least one of facial recognition, biometric assessment, and an identification database, and present a real-time location of the identified object of interest to at least one user.

### CROSS-REFERENCE TO RELATED APPLICATION

The present application claims priority to U.S. Provisional Application No. 63/765,144, filed Feb. 28, 2025, the entirety of which is hereby incorporated by reference.

### FIELD OF THE INVENTION

The present disclosure relates to identification systems, and more particularly, to non-contact-based systems and methods that integrate a plurality of identification means to automatically authenticate and identify individuals, detect objects, and detect physical body motions.

### BACKGROUND

With the advancement of electronic information technology, people's lifestyles are changing. For example, security systems that rely on biometric authentication and/or facial recognition technology are on the rise. Law enforcement agencies began using facial recognition technology around 2016 to assist in identifying suspects and in preventing crimes. As portable, high-capacity, high-performance mobile terminals, such as smartphones, tablets, and notebooks, have become the center of modern people's lifestyles, the number of users who conveniently authenticate themselves for use with such devices, using biometric authentication, including fingerprint, iris, and facial recognition, for example, has also been steadily increasing since around 2017. In addition, within at least some facilities that require security, the user's identification information is registered in advance, and when entering the facility, the user's real-time face image is compared with the previously stored ID card face image to verify their identity.

One of the most commonly used security identification systems relies on facial recognition technology (FRT) wherein facial features are extracted and are compared to data stored in a database. Within such systems, the user's skin does not come into direct contact with the authentication device, and as such, these systems are considered more hygienic and convenient than at least some biometric identification systems. Moreover, FRT systems are often used to provide access to transportation, can be used to detect illness in an individual, and/or to enable keyless entry into facilities.

However, identification systems that rely solely or primarily on facial recognition do have some shortcomings that may out-weigh the benefits of such systems. For example, FRT systems are often trained on imbalanced datasets which can lead to higher identification error rates for people of color, women, children, and/or the elderly. Moreover, the accuracy of the FRT systems often varies by demographic. In addition, FRT systems often require robust data storage and fast processing power on-site, both of which may increase the costs of such technology. One major problem with image and video analysis, such as facial recognition, is the combination of speed and accuracy that is required. While additional hardware may improve the processing for such applications, such hardware can be an expensive proposition. Accordingly, it would be advantageous to be able to provide a system and method of identifying individuals that provides accurate results quickly and in a cost-effective and reliable manner.

### BRIEF SUMMARY

In one aspect, an identification system for use in identifying an object of interest is provided. The identification system includes a plurality of image capture devices, and a controller. The plurality of image capture devices are configured to transmit data in real-time to the controller on demand. The controller is programmed to receive at least one image of an object of interest from a user, compare the at least one image of an object of interest received from the user to data transmitted from the plurality of image capture devices, identify the object of interest from the data transmitted from the plurality of image capture devices using at least one of facial recognition, biometric assessment, and an identification database, and present a real-time location of the identified object of interest to at least one user.

In another aspect, a computer device is provided. The computer device includes at least one memory, and at least one processor in communication with the at least one memory. The at least one processor is programmed to receive at least one image of an object of interest, receive a plurality of current image data on demand from at least one image capture device; and identify the object of interest from the received image data. The at least one processor is further programmed to track the position of the identified object of interest, and to transmit at least one notification message to at least one computing device, wherein each notification message includes a real-time location of the identified object of interest.

In yet another aspect, a method for identifying an object of interest is provided. The method includes receiving, by a processor, at least one image of an object of interest from a user, and receiving, by the processor, a plurality of current image data on demand from a plurality of image capture devices. The method further includes comparing, by the processor, the at least one image of an object of interest to the plurality of current image data, and identifying, by the processor, the object of interest from the plurality of current image data using at least one of facial recognition, biometric assessment, and an identification database. The method also includes tracking, by the processor, a position of the identified object of interest, and transmitting, by the processor, at least one notification message including a real-time location of the identified object of interest to at least one computing device.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a schematic diagram of an exemplary Edge identification (EID) system in accordance with one embodiment of the present disclosure.

FIG. 2 is a schematic of a portion of an exemplary network that may be used with the EID system shown in FIG. 1.

FIG. 3 illustrates an enlarged schematic view of a portion of the network shown in FIG. 2.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

Described herein are computer identification systems, such as the Edge identification system, computing devices and related computer systems. As described herein, all such computer identification systems include a processor and a memory. However, any processor in a computer device referred to herein may also refer to one or more processors that may be in one computing device or a plurality of computing devices that are acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application-specific integrated circuits (ASICs), logic circuits, and any other circuit or processor capable of executing the functions described herein. The above examples are exemplary only and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In one embodiment, a computer identification system is provided, and the system includes an identification program that is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and proceeded with the word “a” or “an” should be understood as not excluding plural elements or steps, unless such exclusion is explicitly recited. Furthermore, references to “example or exemplary embodiment” or to “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

The systems and processes are not limited to the specific embodiments described herein. In addition, components of each system and each process can be practiced independently and separate from other components and processes described herein. Each component and process also can be used in combination with other assembly packages and processes.

As used herein, the term “non-transitory computer-readable media” is intended to be representative of any tangible computer-based device implemented in any method of technology for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including without limitation, volatile and non-volatile media, and removable and non-removable media such as firmware, physical and virtual storage, CD-ROMS, DVDs, and any other digital source such as a network or the Internet, as well as yet to be developed digital means, with the sole exception being transitory, propagating signal.

The processor may execute computer-executable instructions for implementing aspects of this disclosure. In some embodiments, the processor is transformed into a special purpose microprocessor by executing computer-executable instructions or by otherwise being programmed.

The processor may also be operatively coupled to a storage device. The storage device may be any computer-operated hardware suitable for storing and/or retrieving data. In some embodiments, the storage device is integrated in a server system. In other embodiments, the storage device is external to the server system and is similar to a database. For example, the server system may include one or more hard disk drives as storage device. In other embodiments, the storage device may include multiple storage units such as hard disks or solid-state disks in a redundant array of inexpensive disks (RAID) configuration. The storage device may include a storage area network (SAN) and/or a network attached storage (NAS) system. The storage device may include, for example, an Advanced Technology Attachment (ATA) adapter, a Serial ATA (SATA) adapter, a Small Computer System Interface (SCSI) adapter, a RAID controller, a SAN adapter, a network adapter, and/or any component that provides the processor with access to the storage device.

The patent claims at the end of this document are not intended to be construed under 35 U.S.C. § 112(f) unless traditional means-plus-function language is expressly recited, such as, but not limited to, “means for” or “step for” language being expressly recited in the claim(s).

The implementations described herein relate to systems and methods for analyzing images and, more specifically, to analyzing image data to detect, identify, and track objects of interest in the image. Exemplary embodiments of systems and processes that facilitate analyzing image data to detect, identify, and track objects of interest in the image, in an efficient and accurate manner, are described herein. In particular, an Edge Identification (EID) system including an identification computing device works in combination with a neural network and is programmed to (1) learn to identify objects; (2) identify those objects of interest in image or video data; and (3) track those objects over time in real-time. The systems and processes are not limited to the specific embodiments described herein, but rather, components of each system and each process can be practiced independently and separately from other components and processes described herein. Each component and process can also be used in combination with other components and processes.

In the exemplary embodiment, the EID system receives at least one image from a user. In some embodiments, this is a stand-alone image. In other embodiments, this image is one of a series of images. In still further embodiments, the EID system receives video data. In yet further embodiments, the EID system receives data input from a user, such as text or alphanumeric data. In the exemplary embodiment, the image is received in real-time. In some embodiments, the image is of a face or other biometric data, such as a facial scanner image that can be compared to data stored in a database and used to positively identify the individual. In other embodiments, the image is of a location, such as, but not limited to, an amusement park, a concert venue, a park, a playground, a store or mall, a museum, an aquarium, a fair ground, and/or any other venue that has a large physical footprint and that may include a large number of individuals. In still other embodiments, the image is of a city street, a parking lot, a school, a casino floor, and/or any other monitored location.

One or more steps of the process may be performed by the identification computing device. Generally, the process includes collecting image data transmitted from cameras, and using the EID system to identify and/or locate a specific object of interest within the image data, e.g., within individual image frames. The process may further include storing the collected image data to the database and/or storing the image data with the identified objects.

In some embodiments, the process includes analyzing the image data collected by the cameras to locate a particular object of interest, e.g., a missing individual. Such analyzing may include locating and/or identifying, using the image data collected by the cameras, a specific individual in one or more image frames collected by the cameras and then geolocating the identified individual relative to a global coordinate system at the venue.

In one example, an individual may enter a venue, such as a car rental agency or a hotel. A camera may take a picture of the individual's face as the person enters the venue or is approaching the venue. The EID system identifies the person based on the picture, and based on the identification, a car rental check in or a hotel check in process may begin for the person before the person arrives at the car rental check-in desk. By way of another example, a person may approach an airport security screening checkpoint. A camera may take a picture of the person's face or the person's iris. The person may be identified based on the picture. Based upon the identification, various security screening procedures may be set in motion prior to the person arriving at the actual security screening checkpoint. For example, the person may be directed to either a reduced or an increased security screening line based on their identification and based on historical data or additional data associated with the person identified. In another example, a boarding pass may be automatically printed and waiting for the identified person. In still another example, security officials may be called to intercept, detain, and/or arrest the person identified due to outstanding warrants and/or other statuses.

In another example, a person may provide a fingerprint on the way to a car rental kiosk. The person may be identified based on the fingerprint. Based on the identification, a car meeting the person's stored preferences may be prepared and waiting for the person when the person reaches the car rental kiosk. In some cases, payment information may have been obtained and processed as well.

In yet another example, a person may enter the lobby of an office building that the person works in. A camera may monitor the person's gait. The person may be identified based upon their gait. In response to the identification, an elevator may be summoned and programmed to the floor that the person works on prior to the person arriving at a bank of elevators. In some examples, the person may be entering the lobby to go to a floor that the person does not normally work on. In such an example, the system may be configured to recognize an override action, such as the person waving their hand above their head. When the system recognizes that the person who has entered the lobby has performed such an override action, the system may not program the person's usual floor, but rather, the system may still summon an elevator for the person prior to the person's arrival at the elevator bank. The person may then manually indicate the non-normal floor to which the person desires to go.

In some cases, biometric data may be actively and/or passively obtained using various biometric readers. For example, one or more cameras may take one or more pictures of a person's iris, retina, face, gait, and so on. By way of another example, one or more microphones may record the person's voice. In still other examples, the person may intentionally provide one or more fingerprints, facial images, palm prints, and so on. In various cases, various combinations of active and passive biometric gathering may be performed using one or more different biometric readers.

In one embodiment, the EID system may execute a classifier module to identify various depths across the image. More specifically, in such an embodiment, the EID system determines a relative depth of each portion of the image. In some embodiments, the depth classification is performed by analyzing light sources and light source reflections. In other embodiments, the depth classification is performed by analyzing parallel lines to find convergence and/or to determine a parallax, and the relative distances from the viewer are then estimated.

In the exemplary embodiment, the EID system is programmed to analyze the entire image and to detect all objects of interest in the image. In some embodiments, the EID system identifies a portion of the image that can be separated from the remainder of the image. For example, when operating in a facial recognition mode, the EID system may “separate” each iris and each pupil as separate objects, and/or the EID system may detect an individual's nose as a single object. When operating on a location identification mode, the EID system may recognize different objects within the venue as separate objects. For example, within a concert venue, the EID system may identify different seats or chairs within the venue as different objects. In another example, within an amusement park, the EID system may identify different turnstiles or exits as different objects. The EID system may also detect individual objects based on color, shade, lighting, relative distance, and/or text or images, for example, applied to an individual's clothing. In some embodiments, the EID system may detect specific objects such as, but not limited to, an item of clothing such as a hat or shoes worn by an individual.

In the exemplary embodiment, the EID system determines the relative distances of each object from each other based on the width, height, and depth. The EID system generates an identifier for each object. The identifier may include, but is not limited to only including, information about various attributes of the object, including, but not limited to, the size, relative location, saturation hue, and/or any other information necessary to identify the object. In the exemplary embodiment, the identifier includes values for the various attributes of the corresponding object. For example, one set of values in the identifier may be used to describe the color of an object, while another set of values describe the size of the object.

In the exemplary embodiment, the EID system determines the dependencies of the objects based, at least in part, on proximity. For example, the EID system may determine that a hand is associated with a particular arm, or that a hat is associated with an individual, or that a sticker is associated with a hard hat that the sticker is affixed to. In the exemplary embodiment, at this stage, the EID system has identified the different objects and has linked the objects based on their relative proximity in three dimensions.

In the exemplary embodiment, the EID system identifies objects based on their identifiers and their dependencies. In the exemplary embodiment, the EID system stores, in a database, a listing of objects based on context. These listings include a plurality of objects that are each identified by their attributes, using value sets similar to those in the identifiers. The EID system then compares the values of the identifier of the object to those stored in the database to identify the object. To improve the speed of the identification process, the EID system may selectively limit the set of items in the database that it is comparing based on the context. For example, in a concert venue, if the EID system has recognized a hand, then the EID system may search for items that would be around a hand. Or when performing facial recognition, the EID system may recognize a pupil of an eye and then compare nearby objects to the value sets of irises to identify the iris. Furthermore, if two objects have the same identifier or similar identifiers, the EID system may use the identified object's identity as a starting point for identifying the second object. In some embodiments, if the EID system is unable to identify an object, the EID system may selectively search another database or an external database to identify the object.

After the objects are identified, the EID system may determine one or more objects of interest from the plurality of objects identified. In some embodiments, objects are considered objects of interest if they cannot be identified. In other embodiments, objects of interest are determined based on movement or proximity to other objects. In the exemplary embodiment, the EID system can determine the movement and speed of an object based on the object's change in position as compared to previous images. In some embodiments, the EID system can determine the movement and speed of an object based on video data received. In some embodiments, the EID system determines the objects of interest based on their proximity to other objects. For example, if a hand is 20 feet away from a dangerous object, such as an active machine, then the hand is less of interest than if the hand were within arm's reach of the dangerous object.

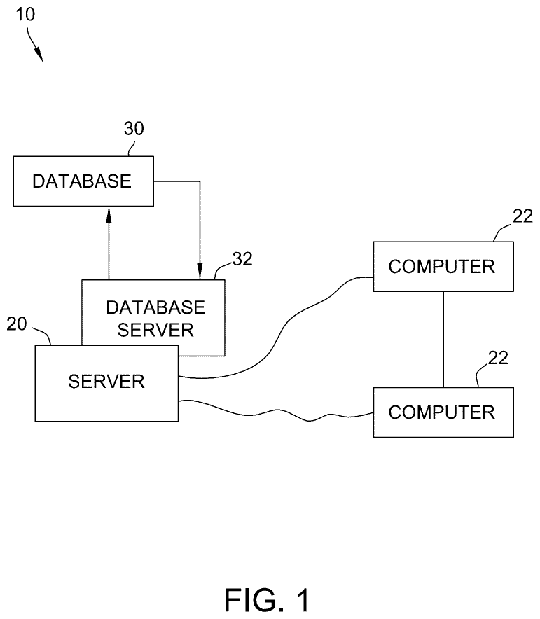

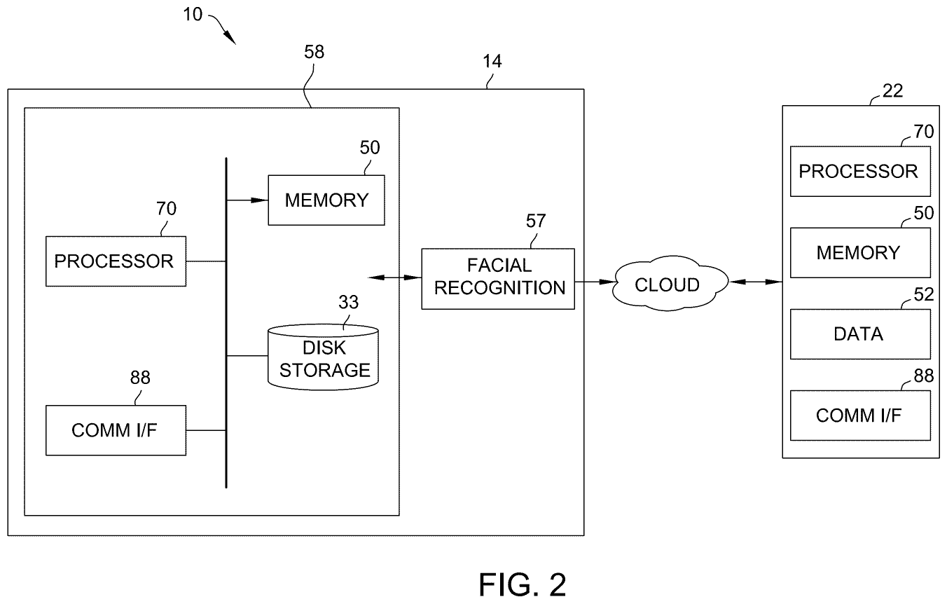

FIG. 1 is a system block diagram for a computer identification system 10 that performs a desired identification function. FIG. 2 is a schematic of a portion of an exemplary network 12 that may be used with an Edge Identification (EID) system 14 for use in analyzing image data to detect, identify, and track objects of interest in real-time. In the exemplary embodiment, system 10 is a cloud-based system used for evaluating uploaded images for use in tracking, identifying, and detecting objects of interest in real-time. In such embodiments, a processor and/or computer on site may be used to detect, identify, and track objects of interest in real time. Moreover, in some embodiments, the data is transmitted via the cloud to an offsite/remote computer to do the processing and the results are transmitted returned to the local devices. Alternatively, system 10 may be a web-based system. In the exemplary embodiment, system 10 includes a server 20 and a plurality of devices 22 connected to the server 20. In one embodiment, the devices 22 are computers including a web browser, and the server 20 is accessible to the devices 22 via the Internet. In an alternative embodiment, the devices 22 are servers for a network of customer devices.

The EID system 14 is coupled to a mass storage device 30. In the exemplary embodiment, a database 30 is stored on the mass storage device 30, and the server 20 includes a database server 32 coupled to the mass storage device 30. The devices 22 are interconnected to the Internet through many interfaces including through a network, such as a local area network (LAN) or a wide area network (WAN), through dial-in-connections, cable modems and/or special high-speed ISDN lines. Alternatively, the devices 22 could be any device capable of interconnecting to the Internet including a web-based phone or other web-based connectable equipment. The database 30, stored on the mass storage device 30, provides information relating to objects to be identified and can be accessed by users at one of devices 22 by logging onto the server 20 through one of devices 22. The server 20 can access stored information and download requested identification data to at least one of the client devices 22, when a request to download is received from a client device 22. In the exemplary embodiment, the database(s) 32 may be accessed by users using a client system configured with a standard web browser.

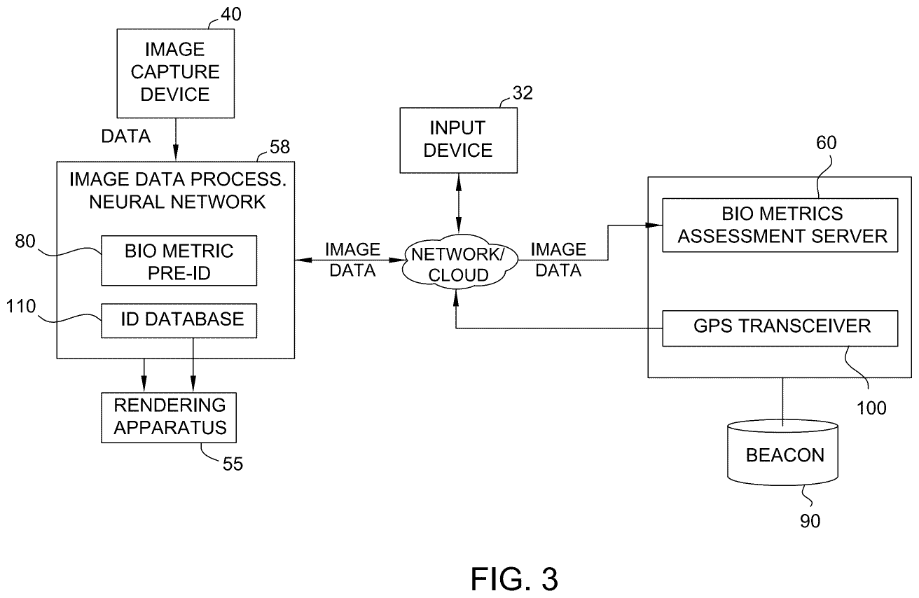

FIG. 2 is an expanded version of an exemplary server architecture of an Edge Identification (EID) system 14 for use in analyzing image data to detect, identify, and track objects of interest in real-time. FIG. 3 illustrates an enlarged schematic view of a portion of the architecture shown in FIG. 2.

Components of system, identical to components of system 10 (shown in FIG. 1), are identified in FIG. 2 using the same reference numerals as used in FIG. 1. The EID system 14 is communicatively coupled to the server sub-system 20 and to user devices 22. The server sub-system 20 may include a database server 32, an application server (not shown), a web server (not shown), a fax server (not shown), a directory server (not shown), and/or a mail server (not shown). A disk storage unit 33 may be coupled to the database server 32 and to the directory server. In the exemplary embodiment, the servers may be coupled in a local area network (LAN). In addition, a system administrator workstation, a user workstation, and a supervisor workstation may be coupled to the LAN. Alternatively, the workstations may be coupled to the LAN via an Internet link or through an intranet. In one embodiment, EID system 14 may be executed via a neural network 12.

In the exemplary embodiment, the EID system 14 includes a plurality of image capture devices 40. In one embodiment, the image capture devices 40 are cameras. The EID system 14 is not limited to only using cameras 40, and rather any device that is capable of capturing original images may be used, including, but not limited to, video cameras, webcams, frame grabber boards, whole slide digital scanners, multispectral fluorescent scopes, and/or smart phones or tablets, for example. Moreover, the cameras 40 may include a neuromorphic camera, a thermal imagining camera, a digital camera, and/or include any device enabled to capture a plurality of image frames, sequential image frames, a video stream, or the like. In the exemplary embodiment, the image capture devices 40 are high definition/high resolution video cameras that provide digital images of objects, including people, within the focal area of the camera 40.

The cameras 40 may collect image data, continuously and/or periodically, and transmit the collected image data to the EID system 14, to a computing device 22, and/or to the database 30. The image data may be transmitted periodically, e.g., every second or every minute, or in any suitable time increment, that enables the EID system 14 to function as described herein.

The cameras 40 are oriented to detect data generated by objects of interest within the focal area of the camera 40. More specifically, the cameras 40 may be oriented in any orientation or location that enables the EID system 14 to function as described herein. For example, when used at a concert venue, the cameras 40 may be oriented to capture images of concert goers and/or attendees as they enter the venue. In another example, when used at an amusement park, the cameras 40 may be oriented to capture images of all traffic, pedestrian, vehicular, or otherwise entering the park and/or passing by designated areas within the park. In yet another example, when used within a casino, additional cameras 40 may be oriented to also capture individuals entering and/exiting elevators, and/or entering VIP designated areas, high-limit rooms, and/or near cashiers. The cameras 40 transmit images through the network 12 wherein the image data transmitted corresponds to pre-defined criteria associated with the EID system 14, such as, but not limited to only being, biometric features of a user, facial features, pre-defined colors, shades, and or lightings, relative distances, and/or texts or images applied to an individual's clothing.

The cameras cooperate with, and interact with, the EID system 14. Moreover, through the network 12, the cameras 40 provide image data to a facial recognition module 51 such that when an individual walks in front of the focal area of a camera 40, the EID system 14 recognizes any pre-defined object data and subsequently transmits data to the network 12 to enable tracking in real-time. For example, in some embodiments, the EID system 14 detects pre-defined individuals in the camera focal area. In some embodiments, the EID system 14 is programmed to identify specific texts or images on banners, clothing, and/or flags, for example, that enter the focal point of cameras. In other embodiments, a user, i.e., a parent or care provider, for example, of the EID system 14 can upload an image, such as a picture of a child, that the user is searching for within the venue, and the EID system 14 can locate the child based on a comparison to the image uploaded by the user. In one embodiment, the EID system 14 is programmed to identify a specific object, such as, but not limited to, an article of clothing, such as a specific shirt, hat, or pair of shoes worn by an individual.

In one embodiment, a user, may be prompted to enter dimensions into the EID system 14, including for example, a height, and/or a sleeve length, of an individual, such as a child, for example, that the user would like entered and “tracked” by the EID system 14. In another embodiment, the EID system 14 includes a rendering apparatus 55 that is able to estimate an individual's dimensions based on the image data received. In one exemplary embodiment, an individual, such as a missing child, may be identified by the EID system 14 based on a comparison of the entered body measurements to a stored library of image data.

The cameras 40 transmit images of the monitored area to the EID system 14. Each image received by the EID system 14 is processed through the network 12 which provides neural network functionality such that each object received is compared in real-time to stored data. The data points and images are also uploaded to the cloud server, wherein the network 12 compares the images to stored data and/or images. Initially, when an image is detected, the cameras 40 transmit the image data to the image data processing neural network 58, which is a component within network 12. The image data processing neural network 58 is coupled to a memory 50 and includes several databases 52 that are pre-programmed with instructions. In some embodiments, in addition to the cameras 40, the network 12 is coupled to an image data processing neural network 58, and/or a biometric assessment server 60, each of which is communicatively coupled to a processor 70.

In some embodiments, the cameras 40 transmit biometric information regarding the physical characteristics of the person to be identified. In some embodiments, biometric matching is performed based on universal and unique features, such as fingerprints and/or retina patterns, or biometric information such as facial expressions and/or voiceprint, and comparisons may be performed in real-time to stored biometric data. In such embodiments, the EID system 14 may include a biometric pre-identification device used to obtain one or more biometrics and/or digital representations thereof for individuals entering a venue, a secure area, and/or a limited-access area, for example. The biometric and/or various digital representations thereof may include, but is not limited to only including, hashes, encrypted data structures, and/or abstract biometric identifiers.

During use, a user, using an input device 84, accesses an application and establishes an account and the user is then prompted to establish a profile. For example, in one embodiment, a parent at an amusement park may establish a profile in the name of a child. In another embodiment, a car rental company employee may establish a profile for a rental customer based on receiving a rental contract. In yet another embodiment, a casino employee may establish a customer profile based on an individual participating in a royalty program and/or based on an individual frequently visiting the casino, spending a pre-determined amount of time and/or money in the casino, and/or based on an individual winning or losing a pre-determined amount of wagers.

The input device 84 may include, for example, a keyboard, a pointing device, a mouse, a stylus, a touch sensitive panel (e.g., a touch pad or a touch screen), a position detector, a biometric input device, and/or an audio input device. Moreover, in the exemplary embodiment, the client input device 84 may be any personal computing device and/or any mobile communications device of a user, such as a personal computer, a tablet computer, a smartphone, and the like. The input device 84 may be configured to present an application (e.g., a smartphone “app”) or a webpage, such as webpage or an app for authenticating a user to the EID system and/or a webpage or app for registering for account access. To this end, the client input device may include or execute software for viewing and interacting with a webpage and/or an app.

A single component such as a touch screen may function as both an output device for the EID system 14, and an input device 84. The user may also enter data and/or an image through a client device 22. In one embodiment, each client device 22 and/or each input device 84 may also include a communication interface 88 that is communicatively coupled via a network 12 to the web server and/or to the database server 32. An exemplary communication interface 88 may include, for example, a wired or wireless network adapter and/or a wireless data transceiver for use with a mobile telecommunications network. In some embodiments, each communication interface may be configured to communicate with and/or receive data, such as one or more location factors, from one or more wireless beacons. More generally, however, any suitable communication interface, such as any suitable radio frequency, Wi-Fi, or BLUETOOTH transceiver and/or receive may be assigned to a user to communicate or receive communications from the EID system 14.

The EID system 14, in the exemplary embodiment, is in communication with a memory area 50 that includes, for example, computer readable instructions for providing a user interface to the user and, optionally, receiving and processing input from their input device 84. A user interface may include, among other possibilities, a web browser and/or a client application. Web browsers enable users to display and interact with the EID system 14 and to receive other information typically embedded on a web page or a website.

In some embodiments, the EID system 14 may receive data from wireless beacons 90 that may be located within the venue or facility, such as within a casino, a limited access area, and/or within a sports book, for example. The wireless beacons 90 may be any suitable electronic device capable of wirelessly transmitting and/or receiving data via one or more communications protocols. In some embodiments, the wireless beacons 90 may be configured to transmit and/or receive a low energy BLUETOOTH signal and/or a Wi-Fi signal. More particularly, in some embodiments, the wireless beacons 90 may include APPLE iBEACON and/or a GOOGLE EDDYSTONE beacon. The wireless beacons 90 may, in addition, be configured to transmit location factors, such as universally unique identifiers (or UUIDs), which may include, in some embodiments, rotating combinations of hexadecimal digits.

In some embodiments, either the client input device 84 and/or the EID system 14 may include a global positioning system (GPS) receiver 100 communicatively coupled to a processor. The GPS receiver 100 may include any suitable GPS receiver 100 that may be implemented within the client device and/or the EID system and that may be configured to receive GPS data, such as one or more GPS coordinates, from one or more GPS satellites. In some embodiments, the GPS receiver 100 may also communicate with one or more cellular system towers to triangulate or otherwise obtain a physical location of the client device, for example.

The database server 32 may be any computer or computer program that provides database services to one or more other computers or computer programs. In various embodiments, the database server 32 may be communicatively coupled between a web server and the database 30. The database server 32 may, in addition, function to process data received from the web server, such as authentication, identification, and/or location verification data, which may include, for example, a first location factor (e.g., GPS data) and/or one or more location factors (e.g., wireless beacon data).

The database 30 may be any organized collection of data, such as, for example, any data organized as part of a relational data structure, any data organized as part of a flat file, and the like. The database 30 may be communicatively coupled to the database server 32 and may receive data from, and provide data to, the database server 32, such as in response to one or more requests for data, which may be provided via a database management system (DBMS) implemented on the database server 32. In various embodiments, the database 30 may be a non-relational database, such as an APACHE HADOOP database.

Although the components of the EID system 14 are described herein and depicted in the Figures as being interconnected in a particular configuration, it is contemplated that the systems, subsystems, hardware and software components, various network components, and database systems described herein may be variously configured and interconnected and may communicate with one another within the EID system 14 to facilitate the processes and advantages described herein. Further, although certain functions, processes, and operations are described herein with respect to one or more system components, it is contemplated that one or more other system components may perform the functions, processes, and operations described herein.

In some embodiments, the EID system 14 may be communicatively coupled to one or more other computing devices 22, associated with one or more interested parties or person(s), such as, for example and without limitation, venue security personnel, law enforcement personnel, and/or any other party that desires to either limit personnel entering a venue, and/or desires to enhance the customer service provided by personnel at a venue, such as check-in hosts, bank tellers, and/or ticket agents, for example. The interested parties or person(s) may refer to any party interested in receiving information regarding the identification of an individual within their venue. In some embodiments, the interested parties may be associated with a computing device 22 that may include a user interface, e.g., a visual and/or audio display, enabling a graphical user interface (GUI) to present information to the interested parties. The computing device 22 may be in communication with other computing devices using an application program interface (API) and an associated, e.g., a front end, GUI, which enables the exchange of data and/or messages. For example, the computing devices 22 may transmit one or more messages including video feed and/or determined identification metrics or data associated with an individual identified within their venue, to other computing devices and/or may cause the other computing devices to display one or more views of the GUI.

In the embodiments described herein, the EID system 14 may also include, or is communicatively coupled to, an identification database 110 enabled to identify specific objects within the image data transmitted from the camera system 40, even if there is a plurality of objects captured in the image data. The identification database 110 may be associated with one or more identification computing devices, not shown, that are separate from the EID system 14. The EID system 14 is also enabled to identify a specific object, even as the object moves between the field of view of adjacent cameras 40 in the camera system 40. In some embodiments, the EID system 14 may utilize an identification marker “attached to” the object, such as, for example, a label or words written on a shirt, and/or a hat worn by an individual. In some embodiments, the EID system 14 may use anatomical markers, to determine one or more biometric body measurements for identifying a specific individual. The EID system 14 may utilize any suitable processes or techniques in order to identify a specific object, including a specific individual in the image data.

In some embodiments, a user may input and store preferences or additional considerations that prioritize, alter, or apply a different weighting to the criteria used within the EID system 14 for the identification process. In some embodiments, a user may directly enter their preferences. For example, at a political rally, if the user is a law enforcement officer, the user may want to prioritize identifying known protestors, demonstrators, advocates, militants, reformers, and/or any other individual that could potentially create a danger to others, for example.

In one example, after a user establishes a profile, the user has the option to input additional photos, such as side photos, and/or full profile photos, etc., of the object (i.e., a person or child) to be tracked or identified. In the exemplary embodiment, after an image has been uploaded to the EID system 14, the user is prompted to enter additional information such as, but not limited to, the name of the individual in the image, their date of birth, their sex, any nicknames for the person in the image, and/or any biometric or additional information that may be helpful in later identifying/distinguishing the individual. In addition, the EID system 14 will determine if the photo uploaded satisfies pre-determined criteria, such as, for example, that the photo is an up-close photo of the individual's head and shoulders, that the individual was looking into the camera, and that the individual is not wearing a hat or sunglasses in the image.

After the profile has been created, and the initial photo has been uploaded, in some embodiments, as the user enters the venue, the EID system 14 may prompt the user to have another photo taken as the user approaches a virtual boundary at the venue, such as but not limited to a GEO fence, beacons 90, proximity markers, and/or any other location-based service. The additional image will also be stored within the EID system 14 and will ensure that the EID system 14 has the most recent photo of the object of interest. More specifically, in the exemplary embodiment, the most recent image is stored within the EID database 30 with encoded information that identifies when/where the image was taken including the date, time, and name of the venue.

In the exemplary embodiment, information uploaded through the application is synched via the cloud and the EID system 14 determines if the object, i.e., the child, is a known object, i.e., the EID system 14 verifies if the individual already has a profile created and if so, associates the uploaded data with a previously stored profile. If the individual or object to be tracked, does not have a profile, and as such, has not previously created a profile, the EID system 14 creates a profile within the database and links and stores any data associated with the individual or object within the database 30.

Later, while at the venue, should the user be unable to locate their child, for example if the child was distracted and wandered away from their parent or vice-versa, the user can request the EID system 14 to begin searching for their child via the application on their input device. More specifically, in one embodiment, the user simply opens the application and holds their finger for a pre-determined amount of time on a designated area of the application, such as, but not limited to, a “lost child hotspot”. After the request has been received by the EID system, the EID begins monitoring data received from cameras, either those currently installed at the venue, i.e., venue legacy cameras, and/or additional EID cameras that were installed as part of the EID system 14 implementation. In addition, the EID system notifies pre-designated venue personal that a child is “missing” and continues searching the cameras that are networked with the EID system 14, i.e., Real Time Streaming Protocol, to locate and identify the missing child.

When the EID system 14 locates a possible object and a comparison to the saved data identifies the individual, the parent is notified of their child's location via a prompt and/or a text transmitted to the input device 84 of the parent. In addition, the venue personnel are also notified of the location of the child. If the child is moving, data from multiple cameras 40 at multiple locations may be used to identify the child, and the parent and the venue personnel may receive multiple pinpoint locations in a color gradient, for example, that illustrates the movement of the child.

In another example, an individual may enter a venue that typically requires a check-in, such as commonly occurs when renting a car, staying at a hotel, entering a medical venue, and/or entering some financial institutes, for example. As the individual enters the venue, a camera 40 may take a picture of the individual's face. The person may be identified based on the picture, and based upon the identification, a car rental check in or a hotel check in process may begin for the person before the person arrives at the car rental check-in desk. In some embodiments, the check in host may receive data from the EID system 14 that enables “settings” to be customized to the individual prior to them checking in, and/or that enables the check-in host to enhance their customer service. For example, a car rental attendant may receive information that the individual prefers sport utility vehicles as opposed to sedans or cars, may typically request a GPS be installed in the car, and/or may receive information that the individual renting the car may not be familiar with a new feature in the car, such as in a newer vehicle, and thus will be able to instruct the driver in the use of the new feature. In another example, a hotel check-in host may receive information that the individual prefers a room overlooking a certain side of the hotel, such as a mountain, or that the individual prefers a room that is closest to the elevator, and/or that the individual had stayed previously at the hotel with their family. In yet another example, a medical facility check in attendant may receive information relevant to allergies or a medical history or condition that the individual has or has been previously treated for.

In yet another example, the EID system 14 is used as a theft deterrent. In such an embodiment, as an individual enters a location or building, such as a warehouse, a camera 40 may also take a picture of the individual's shoes or the clothing worn by the individual. At least one camera may take another picture of each individual approaching an exit of the location or the building. In such an embodiment, the EID system 14 may alert a security guard, for example, if the individual is wearing a different pair of shoes and/or different clothing based on a comparison of the two photos of the individual.

In another example, the EID system 14 may be programmed to initiate an action, such as but not limited to, locking external doors, alerting security guards, flashing lights, and/or transmitting an alert when an individual within a monitored viewing area of a camera performs a pre-determined action. For example, if an individual holds up a certain number of fingers in front of a camera, gestures in a pre-determined manner, and/or does a predetermined series of movements in the viewing area of a camera, such as, but not limited to, pinching their nose, tugging on their ear, and running their hand through their hair, the EID system recognizes the combination of movements and initiates a pre-determined action.

The computer-implemented methods and processes described herein may include additional, fewer, or alternate actions, including those discussed elsewhere herein. The present systems and methods may be implemented using one or more local or remote processors, transceivers, and/or sensors (such as processors, transceivers, and/or sensors mounted on beacons, stations, nodes, or mobile devices, or associated with smart infrastructures and/or remote servers), and/or through implementation of computer-executable instructions stored on non-transitory computer-readable media or medium. Unless described herein to the contrary, the various steps of the several processes described herein may be performed in a different order, or simultaneously in some instances.

Additionally, the computer systems discussed herein may include additional, fewer, or alternative elements and respective functionalities, including those discussed elsewhere herein, which themselves may include or be implemented according to computer-executable instructions stored on non-transitory computer-readable media or medium.

In the exemplary embodiment, a processing element may be instructed to execute one or more of the processes and subprocesses described above by providing the processing element with computer-executable instructions to perform such steps/sub-steps, and store collected data (e.g., individual profiles, etc.) in a memory or storage associated therewith. This stored information may be used by the respective processing elements to make the determinations necessary to perform other relevant processing steps, as described above.

Stored in memory area are, for example, computer readable instructions for providing a user interface to user via their input device and, optionally, receiving and processing input from input device. A user interface may include, among other possibilities, a web browser and/or a client application. Web browsers enable users to display and interact with media and other information typically embedded on a web page or a website. A client application allows the user to interact with, for example, the EID system. For example, instructions may be stored by a cloud service, and the output of the execution of the instructions may be selectively transmitted to a user, to an administrator, to a check-in host/receptionist, and/or to a venue security team, for example.

The aspects described herein may be implemented as part of one or more computer components, such as a client device, system, and/or components thereof, for example. Furthermore, one or more of the aspects described herein may be implemented as part of a computer network architecture and/or a cognitive computing architecture that facilitates communications between various other devices and/or components. Thus, the aspects described herein address and solve issues of a technical nature that are necessarily rooted in computer technology.

The exemplary systems and methods described and illustrated herein therefore significantly increase the accuracy and speed of identifying an object within a venue. The present systems and methods are further advantageous over conventional identification techniques as the embodiments herein are not confined to a single method of identification and/or within a single venue but rather, may instead allow for versatile identification of objects of interest within multiple different types of venues, using multiple layers of data and a plurality of identification methods.

Exemplary embodiments of systems and methods for identifying objects of interest are described above in detail. The systems and methods of this disclosure though, are not limited to only the specific embodiments described herein, but rather, the components and/or steps of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. An identification system for use in identifying an object of interest, the identification system comprising:
a plurality of image capture devices;
a controller, the plurality of image capture devices configured to transmit data in real-time to the controller on demand, the controller programmed to:
receive at least one image of an object of interest from a user;
compare the at least one image of an object of interest received from the user to data transmitted from the plurality of image capture devices;
identify the object of interest from the data transmitted from the plurality of image capture devices using at least one of facial recognition, biometric assessment, and an identification database;
present a real-time location of the identified object of interest to at least one user.

2. The identification system of claim 1, wherein the controller is further programmed to process the data transmitted from the plurality of image capture devices using a neural network.

3. The identification system of claim 1, wherein the controller is further programmed to track the identified object of interest across a field of view of two or more of the plurality of image capture devices.

4. The identification system of claim 1, wherein the controller is further programmed to transmit at least one notification message to at least one computing device associated with venue personnel.

5. The identification system of claim 1, further comprising a facial recognition module communicatively coupled to the controller, wherein the facial recognition module is configured to compare facial features of the object of interest to stored facial data.

6. The identification system of claim 1, further comprising a biometric assessment server communicatively coupled to the controller, wherein the biometric assessment server is configured to perform biometric matching based on at least one of fingerprints, retina patterns, facial expressions, and voiceprint.

7. The identification system of claim 1, further comprising one or more wireless beacons located within a venue, wherein the controller is further programmed to receive location data from the one or more wireless beacons.

8. The identification system of claim 1, further comprising a global positioning system (GPS) receiver communicatively coupled to the controller, wherein the GPS receiver is configured to receive GPS coordinates associated with the identified object of interest.

9. The identification system of claim 1, wherein the controller is further programmed to execute a classifier module to determine a relative depth of each portion of an image received from the plurality of image capture devices.

10. The identification system of claim 1, wherein the controller is further programmed to generate an identifier for the object of interest, the identifier including information about attributes of the object of interest including at least one of size, relative location, and saturation hue.

11. The identification system of claim 1, wherein the controller is further programmed to create a profile for the object of interest and store the profile in a database.

12. A computer device comprising:
at least one memory; and
at least one processor in communication with the at least one memory, the at least one processor programmed to:
receive at least one image of an object of interest;
receive a plurality of current image data on demand from at least one image capture device;
identify the object of interest from the received image data;
track the position of the identified object of interest; and
transmit at least one notification message to at least one computing device, wherein each notification message includes a real-time location of the identified object of interest.

13. The computer device of claim 12, wherein the at least one processor is further programmed to process the received image data using a neural network to identify the object of interest.

14. The computer device of claim 12, wherein the at least one processor is further programmed to geolocate the identified object of interest relative to a global coordinate system.

15. The computer device of claim 12, wherein the at least one processor is further programmed to receive location data from one or more wireless beacons.

16. The computer device of claim 12, wherein the at least one processor is further programmed to determine dependencies between objects based on proximity.

17. A method for identifying an object of interest, the method comprising:
receiving, by a processor, at least one image of an object of interest from a user;
receiving, by the processor, a plurality of current image data on demand from a plurality of image capture devices;
comparing, by the processor, the at least one image of an object of interest to the plurality of current image data;
identifying, by the processor, the object of interest from the plurality of current image data using at least one of facial recognition, biometric assessment, and an identification database;
tracking, by the processor, a position of the identified object of interest; and
transmitting, by the processor, at least one notification message including a real-time location of the identified object of interest to at least one computing device.

18. The method of claim 17, further comprising processing, by the processor, the plurality of current image data using a neural network.

19. The method of claim 17, further comprising geolocating, by the processor, the identified object of interest relative to a global coordinate system at a venue.

20. The method of claim 17, further comprising initiating, by the processor, a pre-determined action based on the identification of the object of interest.
